(19) United States
(12) Patent Application Publication
(10) Pub. No.: US 2013/0187086 A1
(43) Pub. Date: Jul. 25, 2013

(54) PHOSPHORUS-ADSORBING MATERIAL AND PHOSPHORUS RECOVERY SYSTEM

(71) Applicant: KABUSHIKI KAISHA TOSHIBA, TOKYO (JP)

(72) Inventors: Akiko SUZUKI, Tokyo (JP); Hideyuki TSUJI, Yokohama-shi (JP); Shinji MURAI, Sagamihara-shi (JP); Tatsuoki KOHNO, Tokyo (JP); Katsuya YAMAMOTO, Kawasaki-shi (JP); Shinobu MONIWA, Kawasaki-shi (JP); Hidetake SHIIRE, Tokyo (JP); Satoshi HARAGUCHI, Tokyo (JP); Nobuyuki ASHIKAGA, Kawasaki-shi (JP)

(73) Assignee: Kabushiki Kaisha Toshiba, Tokyo (JP)

(21) Appl. No.: 13/793,503

(22) Filed: Mar. 11, 2013

Related U.S. Application Data
(63) Continuation of application No. 13/208,011, filed on Aug. 11, 2011, now abandoned.
Application No. 13/208,011 is a continuation of application No. PCT/JP2010/003733, filed on Jun. 4, 2010.

(30) Foreign Application Priority Data
Jun. 12, 2009 (JP) 2009-141308

(51) Int. Cl. B01J 20/22

(52) U.S. Cl. CPC B01J 20/22
USPC 252/184

(57) ABSTRACT

A phosphorus-adsorbing material is produced to include a polymer-based material modified with at least either of a primary and a secondary amine and a metal supported on the polymer-based material, and a phosphorus recovery system is structured by using the phosphorus-adsorbing material.

### CROSS-REFERENCE TO RELATED APPLICATIONS

This application is a continuation of prior International Application No. PCT/JP2010/003733, filed on Jun. 4, 2010 which is based upon and claims the benefit of priority from Japanese Patent Application No. 2009-141308, filed on Jun. 12, 2009; the entire contents of all of which are incorporated herein by reference.

### FIELD

Embodiments described herein relate to a phosphorus-adsorbing material and a phosphorus recovery system.

### BACKGROUND

For the purpose of removing phosphorus compounds which are, for example, phosphate ions contained in waste water discharged from facilities in a chemical industry, a food industry, a pharmaceutical industry, a fertilizer industry, a sewage treatment plant, a human-waste treatment plant and the like, a reaction coagulation method has been frequently used in which polyvalent metal ions of iron, magnesium, aluminum, calcium or the like are supplied to the waste water and reacted with the phosphate ions to solidify the phosphate ions (or convert them into particles), and the thus solidified phosphate ions are removed through sedimentation, floatation, filtration or the like.

As a method of supplying these polyvalent metal ions to the waste water, there is, for example, an electrolytic method in which metal materials of iron, aluminum or the like are suspended face to face in a liquid, and by applying a voltage to the metal materials to make a current flow, these polyvalent metal ions are dissolved from an anode.

Further, as another method of supplying the polyvalent metal ions to the waste water, there is a coagulant addition method in which a coagulant in a state of aqueous solution of ferric chloride, polyferric sulfate, polyaluminum chloride or the like is supplied with an injection pump.

Other than such a coagulation method through addition of chemicals, there have been known methods such as an adsorption method using an ion-exchange resin, hydrotalcite-like clay mineral, zirconium oxide, or the like.

When desorption operation for reuse is performed on these adsorbing materials, a high-concentration basic solvent is generally used. There is a problem that the high-concentration basic solvent attacks a structure of the adsorbing materials, which results in the deterioration of the structure of the adsorbing materials.

### BRIEF DESCRIPTION OF DRAWINGS

FIG. 1 is a view showing a schematic structure of an apparatus used for phosphorus adsorption in an embodiment.

FIG. 2 is a graph showing reuse characteristics of a phosphorus-adsorbing material in an example.

FIG. 3 is a graph showing reuse characteristics of the phosphorus-adsorbing material in the example.

FIG. 4 is a graph showing reuse characteristics of phosphorus-adsorbing materials in comparative examples.

### DETAILED DESCRIPTION

An aspect of the present invention relates to a phosphorus-adsorbing material characterized in that it includes: a polymer-based material modified with at least either of a primary and a secondary amine; and a metal supported on the polymer-based material.

Hereinafter, details of the present invention as well as other characteristics and advantages will be explained based on embodiments.

### (Phosphorus-Adsorbing Material)

A phosphorus-adsorbing material in the present embodiment has a polymer-based material modified with at least either of a primary and a secondary amine, and a metal supported on the polymer-based material. Hereinafter, each of the components will be described in detail.

### <Polymer-Based Material>

The polymer-based materials to be used in the present embodiment are not particularly limited as long as they exhibit operations and effects of the present invention, but, they are preferably formed of polystyrene and a saccharide. These high-polymer compounds have properties such that they can be easily modified with the primary and/or the secondary amine through treatment such as described below and water can be easily permeated therein. The former property causes the metal that contributes to the phosphorus adsorption to be easily supported on the polymer-based material, and the latter property causes waste water to be easily permeated in the polymer-based material, so that the contact area between the material and the waste water can be increased.

Each of these operations and effects leads to enhance the recovery efficiency of phosphorus from the waste water, so that the formation of the polymer-based materials using the polystyrene and saccharide results in the enhancement of the recovery efficiency of phosphorus. Further, since the polystyrene and saccharide are easy to obtain, it is possible to realize the reduction in cost of the phosphorus-adsorbing material and the phosphorus recovery system in the present embodiment.

Note that in the present embodiment, the polystyrene and saccharide are only required to form main chains of the aforementioned polymer-based materials, so that as the polystyrene, it is possible to use polystyrene cross-linked by divinylbenzene or the like, other than polystyrene alone.

Further, as the saccharide, a polysaccharide is particularly preferable, and among the above, it is preferable to use cellulose which is easy to obtain and inexpensive. Concretely, it is possible to use various cellulosics, cellulose fibers and the like which are commercially available.

Further, instead of the aforementioned polystyrene and saccharide, it is also possible to use in solubilized polyvinyl alcohol (PVA) or phenol resin. As insoluble treatment, cross-linking treatment or the like can be exemplified.

The polymer-based material is required to be modified with the primary and the secondary amine. This is to make it easy for the metal that contributes to the phosphorus adsorption to be supported on the material, as described above.

As the primary and the secondary amine, it is preferable to use at least one kind selected from the group consisting of polyethyleneimine and amino compounds represented by chemical formulas 1 to 6,

[Chemical formula 1]

Siₗ—(CH₂)mNH₂ (1)

[Chemical formula 2]

Siₗ—(CH₂)nNH(CH₂)mNH₂ (2)

[Chemical formula 3]

Rₗ—N[(CH₂)mNH₂]₂ (3)

[Chemical formula 4]

Rₗ—NL(CH₂)mNHCHCH₂NH₂ (4)

[Chemical formula 5]

Rₗ—NL(CH₂)mNH₂ (5)

[Chemical formula 6]

C₆H₄(CH₂)mNH₂ (6)

(where “n” represents an integer of 0 to 3, “m” represents an integer of 1 to 3, “l” represents 0 or 1, “R” represents CH₂CHOHCH₂, and “L” represents an alkyl chain with a hydrogen or carbon number of 1 to 3).

Next, explanation will be made on a method of modifying the polymer-based materials with the above-described amino compounds. Note that hereinbelow, a preferable polymer-based material is used as a representative, for easier understanding.

When the polymer-based material is modified with the amino compound represented by the chemical formula 1, the modification is conducted by, for example, mixing 3-aminopropyltrimethoxysilane and the polymer-based material (cellulose, in the present example) in a water-ethanol solvent, filtering the mixture and then washing the filtered mixture, as represented by the following reaction formula.

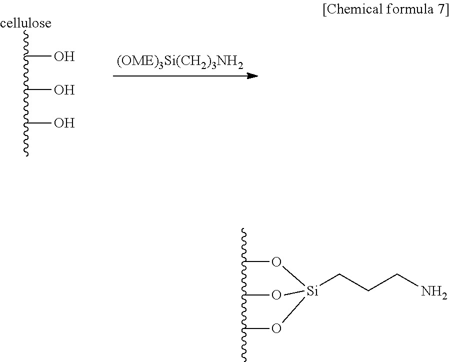

When the polymer-based material is modified with the amino compound represented by the chemical formula 2, the modification is conducted by, for example, mixing 3-(2-aminoethyl)aminopropyltrimethoxysilane and the polymer-based material (cellulose, in the present example) in a water-ethanol solvent, filtering the mixture and then washing the filtered mixture, as represented by the following reaction formula.

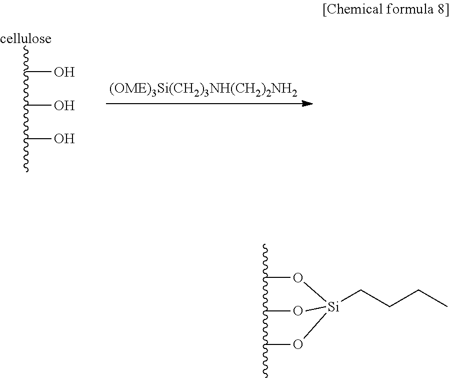

When the polymer-based material is modified with the amino compound represented by the chemical formula 3 or the chemical formula 4, for example, an epoxy compound having a chlorinated end obtained through the reaction between benzyl trimethyl ammonium hydroxide and epichlorohydrin, is reacted with the polymer-based material (cellulose, in the present example) in an alkaline atmosphere to modify the end of the polymer-based material with the epoxy compound, and thereafter, by stirring the modified polymer-based material and diethylenetriamine in an aprotic solvent such as dimethylsulfoxide (DMSO) or dimethylformamide (DMF), (the end of) the polymer-based material can be modified with the amino compound represented by the chemical formula 4, as represented by the following reaction formula.

Note that instead of obtaining the epoxy compound through the reaction as described above, the polymer-based material and diethylenetriamine can be bonded by using (through) a silane coupling agent having an epoxy group to be modified with the amino compound represented by the chemical formula 3 or 4 as described above. Further, it is also possible to perform the modification using the amino compound represented by the chemical formula 3 or 4 by making commercially available epoxy resin and diethylenetriamine react in a an aprotic solvent such as dimethylsulfoxide (DMSO) or dimethylformamide (DMF).

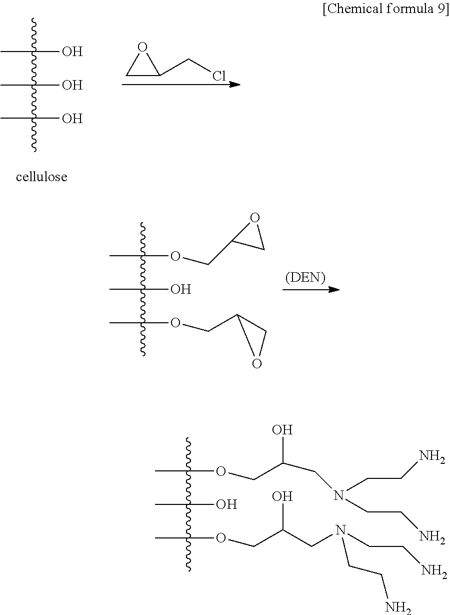

Note that, when the end of the polymer-based material is modified with the amino compound represented by the chemical formula 5, the modification can be conducted by, for example, reacting N-ethylethylenediamine and N-isopropylethylenediamine or the like, instead of diethylenetriamine in the above-described reaction formula, in an alcohol solvent or a water solvent.

When the polymer-based material is modified with the amino compound represented by the chemical formula 6, the modification can be performed by, for example, reacting a hydroxyl group of aminophenol with epichlorohydrin, and then heating for the polymerization of an epoxy compound with the reacted compound. A functional group of aminophenol can be in any of ortho, para, or meta position. Note that an epoxy group of the epoxy compound functions as a functional group with which the epoxy compound and the reacted compound are highly-polymerized through being mutually polymerized.

When the polymer-based material is modified with polyethyleneimine, polyethyleneimine is used instead of diethylenetriamine at the time of modifying the polymer-based material with the amino compound represented by the chemical formula 4, and the reacted compound is heated in an aprotic solvent such as dimethylsulfoxide (DMSO) or dimethylformamide (DMF), and thus the modification can be conducted.

Note that the above-described modification patterns are only examples, and the modification method in the present embodiment is not limited to the above contents. For example, it is also possible to use N-2-(aminoethyl)-3-aminopropylmethyldimethoxysilane, N-2-(aminoethyl)-3-aminopropyltriethoxysilane, 3-aminopropyldimethylethoxysilane or the like, instead of 3-aminopropyltrimethoxysilane and 3-(2-aminoethyl)aminopropyltrimethoxysilane.

### <To Support Metal Ions>

Next, a metal is supported on the polymer-based material obtained as described above. In this case, for example, there can be cited a method in which a predetermined reagent is used to adjust an aqueous solution to set a concentration of the metal within a range of 0.1 wt % to 20 wt %, and then the polymer-based material is immersed and stirred in the aqueous solution, or a method in which the polymer-based material is packed in a column, and the above-described aqueous solution is flowed through the column.

In the present embodiment, the metal supported on the polymer-based material as described above mainly contributes to the adsorption of phosphorus in a wastewater. Specifically, phosphorus in the waste water mainly exists in a state of anion such as H₂PO₄⁻, HPO₄²⁻ and PO₄³⁻. Therefore, it can be considered that a counter anion of the metal which is supported on the polymer-based material, namely, the phosphorus-adsorbing material is exchanged with an anion of a phosphorus compound having a higher affinity than the counter anion, resulting in that the phosphorus compound in the waste water becomes to be adsorbed in the phosphorus-adsorbing material, and thus the recovery of phosphorus from the waste water can be conducted.

Therefore, in the recovery of phosphorus (compound) to be described in detail hereinbelow, since it is sufficient only to perform desorption of anion of the phosphorus compound exchanged with the counter anion of the metal supported on the phosphorus-adsorbing material, it is possible to recover the phosphorus compound only by performing washing with a solvent such as one of which pH is relatively close to neutral, without using a solvent such as a conventionally used one with high basic concentration, as described above. Concretely, the phosphorus compound can be recovered only by performing washing with a solvent of which pH is in a range of 3<pH<10.

Note that in the actual desorption operation, as will be described in detail hereinbelow, a solvent containing calcium salt such as calcium chloride or calcium carbonate (neutral solvent) is used, and by reacting the solvent with the phosphorus compound, the phosphorus compound can be precipitated and recovered in a form of calcium phosphate, for example. Further, by bringing the phosphorus-adsorbing material into contact with a basic aqueous solution such as a sodium hydroxide aqueous solution with relatively low basic concentration to obtain a solution contacting the phosphorus compound, and then adding an excessive amount of sodium hydroxide or calcium chloride to the solution, phosphate ions are precipitated as sodium phosphate salt or calcium phosphate, and by filtering the precipitation, the phosphorus compound can be recovered.

Note that a kind of metal to be supported is not particularly limited and, for instance, iron and zinc can be exemplified. Regarding these metals, since a metal reagent to be a raw material is easy to obtain and inexpensive, it becomes possible to sufficiently reduce the cost of the above-described phosphorus-adsorbing material and phosphorus recovery system.

### (Adsorption and Desorption Operation of Phosphorus)

Next, adsorption and desorption operation of phosphorus according to the embodiment will be explained.

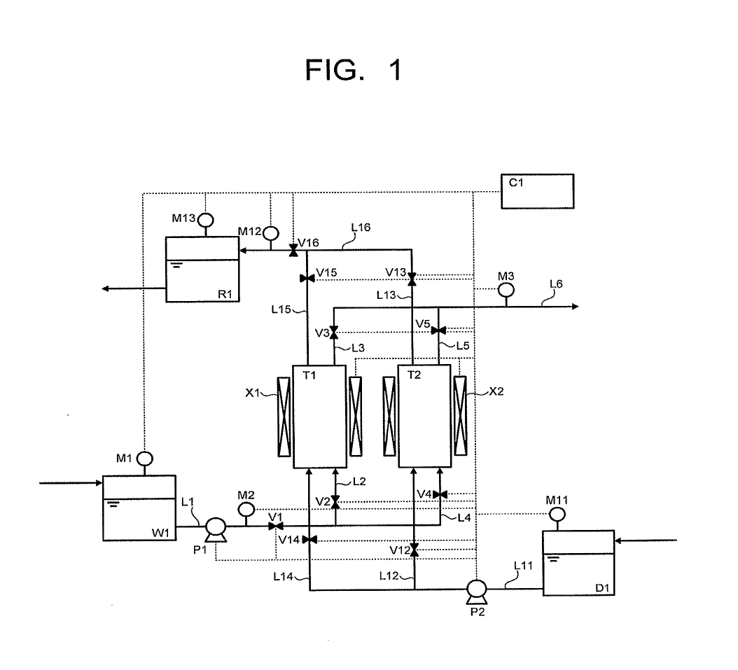

FIG. 1 is a view showing a schematic structure of an apparatus to be used for phosphorus adsorption in the present embodiment. As shown in FIG. 1, in the present apparatus, adsorption units T1 and T2 packed with the aforementioned phosphorus-adsorbing material are disposed in parallel, and on lateral sides of the adsorption units T1 and T2, contact efficiency accelerators X1 and X2 are provided. The contact efficiency accelerators X1 and X2 can be provided as mechanical stirrers or non-contact magnetic stirrers, but, they are not essential components and thus can also be omitted.

Further, for the adsorption units T1 and T2, a storage tank of medium to be treated W1, in which a medium to be treated containing phosphorus is stored, is provided via supply lines L1, L2 and L4, and the units are connected to the outside via discharge lines L3, L5 and L6. Further, to the adsorption units T1 and T2, a desorption medium storage tank D1, in which a desorption medium is stored, is connected via supply lines L11, L12 and L14, and a desorption medium recovery tank R1 is connected via discharge lines L13, L15 and L16.

Note that to the supply lines L1, L2, L4, L12 and L14, there are provided valves V1, V2, V4, V12 and V14, respectively, and to the discharge lines L3, L5, L13, L15 and L16, there are provided valves V3, V5, V13, V15 and V16, respectively. Further, to the supply lines L1 and L11, pumps P1 and P2 are provided. In addition, to the storage tank of medium to be treated W1, the supply line L1 and the discharge line L6, concentration measuring units M1, M2 and M3 are respectively provided, and to the desorption medium storage tank D1, the discharge line L16 and the desorption medium recovery tank R1, concentration measuring units M1, M11 and M13 are respectively provided.

Further, the control of the aforementioned valves and pumps, and the monitoring of measured values in the measuring units are collectively and centrally controlled by a controller C1.

Next, explanation will be made on the adsorption and desorption operation of phosphorus using the apparatus shown in FIG. 1.

First, the medium to be treated is supplied from the tank W1 to the adsorption units T1 and T2 through the supply lines L1, L2 and L4 using the pump P1. At this time, phosphorus in the medium to be treated is adsorbed in the adsorption units T1 and T2, and the medium to be treated after the adsorption is performed is discharged to the outside through the discharge lines L3 and L5.

At this time, it is possible to enhance the adsorption efficiency of phosphorus provided by the adsorption units T1 and T2, by driving the contact efficiency accelerators X1 and X2 according to need, and to increase a contact area between the phosphorus-adsorbing material packed in the adsorption units T1 and T2 and the medium to be treated.

Here, adsorption states of the adsorption units T1 and T2 are observed by the concentration measuring unit M2 and the concentration measuring unit M3 provided on the supply side and the discharge side, respectively, of the adsorption units T1 and T2. When the adsorption proceeds smoothly, the concentration of phosphorus measured by the concentration measuring unit M3 indicates a value lower than that of the concentration of phosphorus measured by the concentration measuring unit M2. However, as the adsorption of phosphorus in the adsorption units T1 and T2 gradually proceeds, the difference in concentration of phosphorus in the concentration measuring units M2 and M3 disposed on the supply side and the discharge side is decreased.

Therefore, when the value measured by the concentration measuring unit M3 reaches a previously set predetermined value, and it is judged that adsorptivity of phosphorus of the adsorption units T1 and T2 reaches saturation, the controller C1 once stops the pump P1, closes the valves V2, V3 and V4, and stops the supply of the medium to be treated to the adsorption units T1 and T2, based on the information from the concentration measuring units M2 and M3.

Note that, although not illustrated in FIG. 1, when a pH of the medium to be treated fluctuates, or the pH is strongly acidic or strongly basic and is out of a pH range suitable for the adsorbing material according to the present invention, it is also possible that the pH of the medium to be treated is measured by the concentration measuring unit M1 and/or M2 and is adjusted through the controller C1.

After the adsorptivity of phosphorus of the adsorption units T1 and T2 reaches saturation, the desorption medium is supplied from the desorption medium storage tank D1 to the adsorption units T1 and T2 through the supply lines L11, L12 and L14 using the pump P2. The phosphorus adsorbed in the adsorption unit T2 is eluted (desorbed) in the desorption medium, and the medium is discharged to the outside of the adsorption units T1 and T2 through the discharge lines L13, L15 and L16, and recovered in the recovery tank R1. Note that it is also possible to design such that the medium is discharged to the outside without being recovered in the recovery tank R1. Further, it is also possible that precipitated phosphorus is filtered to be recovered. Note that a pH of the aforementioned desorption medium can be set to fall within a range of 3<pH<10, as described above.

When the desorption of phosphorus from the adsorption units T1 and T2 with the use of the desorption medium proceeds smoothly, the concentration of phosphorus of the desorption medium measured by the concentration measuring unit M12 provided on the discharge side indicates a value higher than a value measured by the concentration measuring unit M11 provided on the supply side. However, as the desorption of phosphorus in the adsorption units T1 and T2 gradually proceeds, the difference in concentration of phosphorus in the concentration measuring units M11 and M12 disposed on the supply side and the discharge side is decreased.

Therefore, when the value measured by the concentration measuring unit M12 reaches a previously set predetermined value, and it is judged that phosphorus desorption capability of the adsorption units T1 and T2 with the use of the desorption medium reaches saturation, the controller C1 once stops the pump P2, closes the valves V12 and V14, and stops the supply of the medium to be treated to the adsorption units T1 and T2, based on the information from the concentration measuring units M11 and M12.

After the desorption of phosphorus from the adsorption units T1 and T2 is completed as described above, the medium to be treated is again supplied from the storage tank of medium to be treated W1, and adsorbs phosphorous so that the phosphorus in the medium to be treated can be reduced through adsorption.

Note that the concentration measuring unit M13 is structured to appropriately measure the concentration of phosphorus in the desorption medium recovery tank R1 according to need.

Further, although in the above-described example, the adsorption units T1 and T2 are made to simultaneously perform the adsorption of phosphorus, and are also made to simultaneously perform the desorption of phosphorus, the adsorption units T1 and T2 may be structured so as to alternately perform these operations. For example, it is also possible to design such that, the adsorption unit T1 first performs the adsorption of phosphorus, and after the adsorptivity reaches saturation, the desorption of phosphorus as described above is performed on the adsorption unit T1, and at the same time, the adsorption of phosphorus is conducted in the adsorption unit T2.

In this case, since the adsorption of phosphorus can be constantly performed in either the adsorption unit T1 or T2 in the apparatus shown in FIG. 1, it becomes possible to perform continuous operation.

Note that an amount of the desorption solvent is preferably not less than two times nor more than ten times the volume of the adsorption units T1 and T2. When the amount is smaller than two times the volume, there is a possibility that the desorption of phosphorus cannot be sufficiently and efficiently performed, and when the amount is larger than ten times the volume, the cost of the chemical is increased, which is inefficient.

As the desorption solvent, a solvent containing calcium salt such as calcium chloride or calcium carbonate can be used. By bringing the phosphorus-adsorbing material into contact with such a desorption medium, the phosphorus compound adsorbed in the phosphorus-adsorbing material and the calcium are reacted, and the phosphorus compound can be precipitated and recovered in a form of calcium phosphate, for example.

In this case, the concentration of calcium salt is preferably not less than 0.1 mol/L nor more than 3 mol/L, and is more preferably not less than 0.5 mol/L nor more than 1.5 mol/L. When the concentration is lower than 0.5 mol/L, the precipitation of calcium phosphate is slow, and when the concentration is higher than 3 mol/L, the salt concentration is so high that the phosphorus-adsorbing material has to be subjected to washing operation when reused. When a column tower is used, the precipitated calcium phosphate may become a cause of clogging.

Further, it is also possible to make the phosphorus-adsorbing material to be brought into contact with a basic aqueous solution such as a sodium hydroxide aqueous solution to desorb the phosphorus compound. In this case, the concentration of sodium hydroxide aqueous solution is preferably not less than 0.05 mol/L nor more than 1.5 mol/L, and is more preferably not less than 0.1 mol/L nor more than 1.0 mol/L. When the concentration is lower than 0.05 ml/L, the desorption efficiency of phosphorus compound is poor, and when the concentration is higher than 1.5 mol/L, the deterioration of phosphorus-adsorbing material is accelerated due to an influence of strong basicity.

When a sodium hydroxide aqueous solution or a sodium chloride aqueous solution is used, by adding an excessive amount of sodium hydroxide or calcium chloride to the aqueous solution obtained as a result of desorbing the phosphorus compound, phosphate ions are precipitated as sodium phosphate salt or calcium phosphate. By filtering the resultant, the phosphorus compound can be recovered.

As described above, the desorption from the phosphorus-adsorbing material can also be carried out not only with a basic solvent but also with a neutral solvent, so that it is possible to prevent the deterioration of structure of the phosphorus-adsorbing material. Note that the term “neutral” herein indicates a range of pH of 6 to 8, when measuring the pH at 25° C.

### EXAMPLES

Next, the present invention will be more specifically explained using examples.

### Example 1

A compound of 2 g obtained by modifying polystyrene with benzylamine was added to an aqueous solution of 10 ml containing iron chloride of 0.6 g, and the mixture was stirred for 2 hours so that iron was supported on the compound. The thus obtained compound was filtered and then dried in a dryer at 70° C., thereby obtaining a phosphorus-adsorbing material.

Next, the above-described phosphorus-adsorbing material of 100 mg was added to a water to be treated of 50 ml with a P concentration adjusted to 40 ppm-P, the mixture was stirred for 3 hours using a rotary mixer (manufactured by NISSIN), and phosphorus adsorption performance test was conducted. The solution after performing the treatment was collected, and an adsorption amount was calculated based on a concentration of residual phosphorus in the solution. Results thereof are shown in Table 1. Note that measurement of the concentration of residual phosphorus was conducted with the use of an inductively coupled plasma emission spectrography.

### Example 2

A phosphorus-adsorbing material was produced in the same manner as in the example 1, except that zinc chloride of 0.6 g was used instead of the iron chloride, and the adsorption performance test was conducted. Results thereof are shown in Table 1.

### Example 3

After obtaining a compound of 2 g as a result of modifying cellulose with aminopropyltrimethoxysilane, iron was supported on the compound through the same method as that in the example 1 to obtain a phosphorus-adsorbing material, and then the adsorption performance test was conducted. Results thereof are shown in Table 1.

### Example 4

After obtaining a compound of 2 g as a result of modifying cellulose with 3-(2-aminoethyl) aminopropyltrimethoxysilane, iron was supported on the compound through the same method as that in the example 1 to obtain a phosphorus-adsorbing material, and then the adsorption performance test was conducted. Results thereof are shown in Table 1.

### Example 5

A phosphorus-adsorbing material was obtained in the same manner as in the example 4, except that zinc was used, and then the adsorption experiment was conducted in the same manner as in the example 1. Results thereof are shown in Table 1.

### Example 6

After obtaining a compound of 2 g as a result of modifying polystyrene with an aminoethyl group, iron was supported on the compound through the same method as that in the example 1 to obtain a phosphorus-adsorbing material, and then the adsorption performance test was conducted. Results thereof are shown in Table 1.

### Example 7

After obtaining a compound of 2 g as a result of modifying cellulose with diethylenetriamine, iron was supported on the compound through the same method as that in the example 1 to obtain a phosphorus-adsorbing material, and then the adsorption performance test was conducted. Results thereof are shown in Table 1.

### Example 8

After obtaining a compound of 2 g as a result of modifying cellulose with polyethyleneimine, iron was supported on the compound through the same method as that in the example 1 to obtain a phosphorus-adsorbing material, and then the adsorption performance test was conducted. Results thereof are shown in Table 1.

TABLE 1

| | POLYMER-BASED | | AMINE | | | | | | | | ADSORPTION |
|---|---|---|---|---|---|---|---|---|---|---|---|
| | MATERIAL | | CHEMICAL | CHEMICAL | CHEMICAL | CHEMICAL | CHEMICAL | | METAL ION | | AMOUNT OF |
| | | SACCHARIDE | FORMULA | FORMULA | FORMULA | FORMULA | FORMULA | | IRON | ZINC | PHOSPHORUS |
| | PS | SKELETON | 1 | 2 | 3 | 4 | 5 | PI | ION | ION | (mg-P/g) |
| EXAMPLE 1 | ◯ | | | | | | ◯ | | ◯ | | 17.1 |
| EXAMPLE 2 | ◯ | | | | | | ◯ | | | ◯ | 16.4 |
| EXAMPLE 3 | | ◯ | ◯ | | | | | | ◯ | | 8.2 |
| EXAMPLE 4 | | ◯ | | ◯ | | | | | ◯ | | 7.7 |
| EXAMPLE 5 | | ◯ | | ◯ | | | | | | ◯ | 7.2 |
| EXAMPLE 6 | ◯ | | ◯ | | | | | | ◯ | | 10.1 |
| EXAMPLE 7 | | ◯ | | | ◯ | ◯ | | | | | 15.1 |
| EXAMPLE 8 | | ◯ | | | | | | ◯ | ◯ | | 18.9 |

*PI: POLYETHYLENIMINE

As is apparent from Table 1, it was proved that, with the use of the phosphorus-adsorbing materials obtained in the examples 1 to 8, phosphorus with a concentration of 7.2 ppm to 18.9 ppm was adsorbed to be removed from the solution containing phosphorus with a concentration of 40 ppm provided for the test. Specifically, it was proved that a relatively large amount of phosphorus can be adsorbed by the phosphorus-adsorbing materials of the present examples.

### Example 9

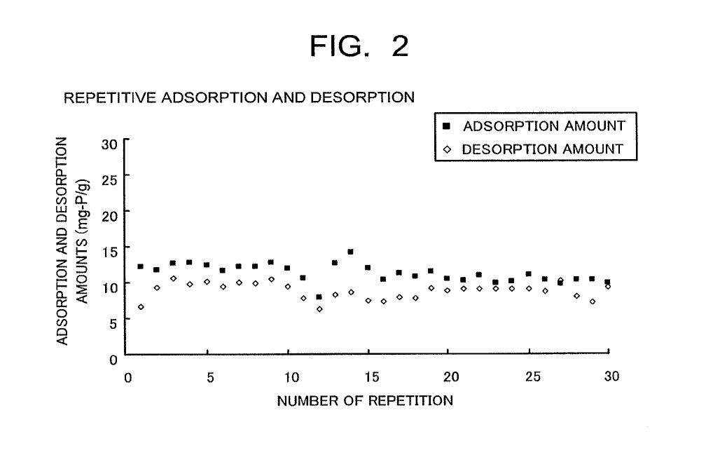

Next, the reuse characteristics of the phosphorus-adsorbing material obtained in the example 1 were examined. An aqueous solution of 50 ml in which a P concentration was adjusted to 40 ppm by sodium hydrogen phosphate was used as a water to be treated, and an aqueous solution of 50 ml containing 0.001N-HCL and 1N—NaCl was used as a solution for desorption and regeneration (pH=3). The adsorbing material of 100 mg produced in the example 1 was put in the water to be treated, stirred for 30 minutes using the rotary mixer (manufactured by NISSIN), and after the water to be treated was collected, the adsorbing material was filtered and added to the solution for desorption and the stirring was performed in the same manner. The solution for desorption and regeneration was collected after 30 minutes while the adsorbing material was filtered and then added again to the water to be treated with a P concentration of 40 ppm. This operation was repeatedly conducted, and thereafter, the concentration of phosphorus in the collected solution was measured by the ICP, and the adsorption and desorption amounts were calculated. Results thereof are shown in FIG. 2.

As is apparent from FIG. 2, it was proved that almost no decrease in adsorption amount and desorption amount of the adsorbing material was observed in the repetitive use for about 30 times, and thus the phosphorus-adsorbing material obtained in the example 1 does not deteriorate almost at all even in a case of using the solution for desorption and regeneration (pH is 3), and has a high phosphorus adsorptivity over a long period of time.

### Example 10

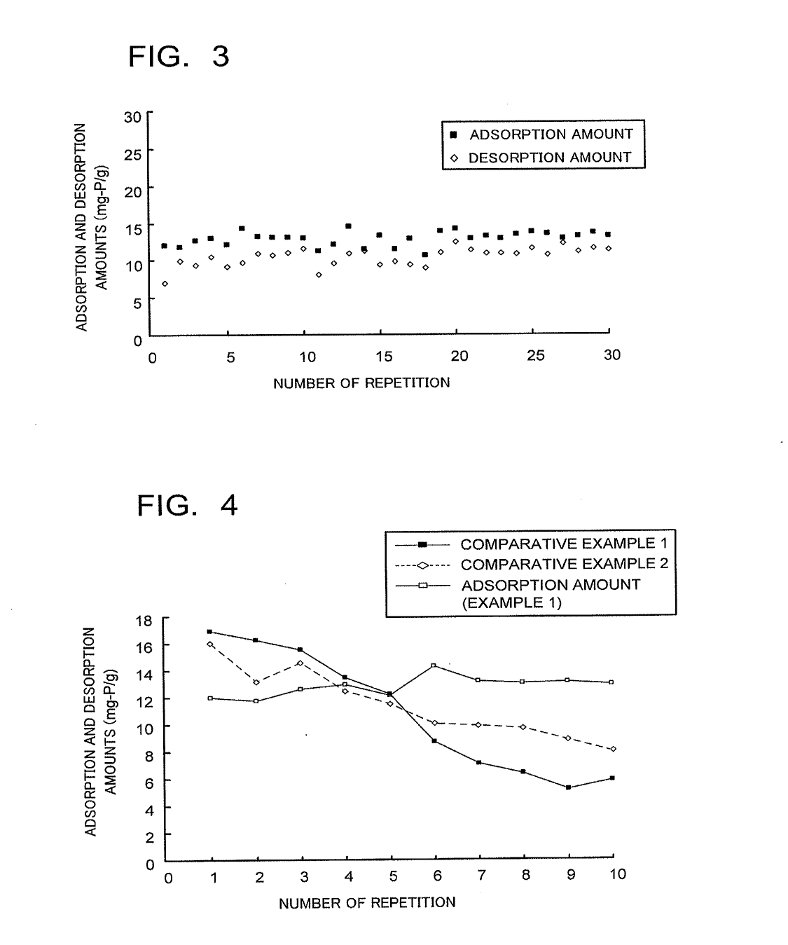

By using a 1N—NaCl aqueous solution as the solution for desorption and regeneration, the reuse characteristics of the phosphorus-adsorbing material obtained in the example 1 were examined in the same manner as in the example 9. Results obtained by calculating the adsorption and desorption amounts are shown in FIG. 3. As is apparent from FIG. 3, also in the present example, it was proved that almost no decrease in adsorption amount and desorption amount of the adsorbing material was observed in the repetitive use for about 30 times, and thus the phosphorus-adsorbing material obtained in the example 1 does not deteriorate almost at all even in a case of using the neutral solution for desorption and regeneration, and has a high phosphorus adsorptivity over a long period of time.

### Comparative Examples 1 and 2

By using an adsorbing material containing a silica gel carrier modified with aminopropyltrimethoxysilane and iron ions were further supported on the silica gel (comparative example 1), and an adsorbing material containing a silica gel carrier modified with 3-(2-aminoethyl)aminopropyltrimethoxysilane and iron ions were further supported (comparative example 2) on the silica gel, the reuse characteristics of the phosphorus-adsorbing materials were examined in the same manner as in the example 9. Results obtained by measuring the concentration of phosphorus in the collected solution using the ICP and calculating the adsorption and desorption amounts, are shown in FIG. 4. Note that for reference, the result when the phosphorus-adsorbing material in the example 1 was used, was also collectively shown in FIG. 4.

As is apparent from FIG. 4, a certain level of phosphorus adsorptivity is provided, although only initially, by the adsorbing materials disclosed in the comparative examples 1 and 2 different from the present invention, but, when the number of repetitive use (the number of reuse) exceeds 5, it can be confirmed that the phosphorus adsorptivity is extremely reduced, compared with the phosphorus-adsorbing material in the example 1 in accordance with the present invention. Specifically, it was proved that the phosphorus-adsorbing material in accordance with the present invention exhibits high phosphorus adsorptivity as well as high reuse characteristics.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1.-5. (canceled)

6. A phosphorus-adsorbing material, comprising:
a saccharide modified with at least one of a primary and a secondary amine; and
a metal supported on said saccharide and including a counter anion that exchanges with an anion of a phosphorous compound.

7. The phosphorus-adsorbing material according to claim 6,
wherein the metal is at least one of iron and zinc.

8. The phosphorus-adsorbing material according to claim 6,
wherein the amine is at least one kind selected from the group consisting of polyethyleneimine and amino compounds represented by chemical formulas 1 to 6:
Siₗ—(CH₂)ₘNH₂ (Chemical formula 1);
Siₗ—(CH₂₎ₙNH(CH₂)ₘNH₂ (Chemical formula 2);
Rₗ—N[(CH₂)ₘNH₂]₂ (Chemical formula 3);
Rₗ—NL(CH₂)ₘNHCHCH₂NH₂ (Chemical formula 4);
Rₗ—NL(CH₂)ₘNH₂ (Chemical formula 5); and
C₆H₄(CH₂)ₘNH₂ (Chemical formula 6),
where “n” represents an integer of 0 to 3, “m” represents an integer of 1 to 3, “l” represents 0 or 1, “R₁” represents CH₂CHOHCH₂, and “L” represents an alkyl chain with a hydrogen or carbon number of 1 to 3.

9. A phosphorus recovery system using the phosphorus-adsorbing material according to claim 6.
